(19) United States
(12) Patent Application Publication
(10) Pub. No.: US 2026/0277741 A1
(43) Pub. Date: Sep. 17, 2026

(54) MEMORY SYSTEM, DECODING CIRCUIT AND METHOD

(71) Applicant: Kioxia Corporation, Tokyo (JP)

(72) Inventors: Kosuke MORINAGA, Yokohama Kanagawa (JP); Tadakazu NOMURA, Yokohama Kanagawa (JP)

(73) Assignee: Kioxia Corporation, Tokyo (JP)

(21) Appl. No.: 19/234,373

(22) Filed: Jun. 11, 2025

(30) Foreign Application Priority Data
Mar. 14, 2025 (JP) 2025-040791

(51) Int. Cl. G06F 11/10; G06F 5/01

(52) U.S. Cl. CPC G06F 11/1068; G06F 5/01; G06F 11/1048

(57) ABSTRACT

According to an embodiment, a memory controller performs, for each of a plurality of first sections obtained by dividing a first symbol string in units of a first length, a first conversion operation of converting an arrangement order of symbols in one first section with a conversion pattern corresponding to a position of one first section in the first symbol string. The memory controller performs, for each of the plurality of first sections after the first conversion operation, a second conversion operation of converting an arrangement order of symbols in one first section with a conversion pattern common to the plurality of first sections. The memory controller performs decoding using parity on the plurality of first sections after the second conversion operation.

### CROSS-REFERENCE TO RELATED APPLICATIONS

This application is based upon and claims the benefit of Japanese Patent Application No. 2025-040791, filed on Mar. 14, 2025; the entire contents of which are incorporated herein by reference.

### FIELD

The present embodiment relates generally to a memory system, a decoding circuit, and a method.

### BACKGROUND

In a memory system, in order to protect data stored in a nonvolatile memory such as a NAND flash memory, error correction encoding is performed on data to be written to the nonvolatile memory. Therefore, when the data stored in the nonvolatile memory is read, a decoding circuit decodes the error correction encoded data (also referred to as a received word) read from the nonvolatile memory, so that the error included in the received word is corrected.

In the memory system, in addition to a random error and a burst error, an error having periodicity (hereinafter, a periodic error) caused by periodic electrical noise or the like may occur.

### BRIEF DESCRIPTION OF THE DRAWINGS

FIG. 1 is a block diagram illustrating a schematic configuration example of a memory system according to an embodiment;

FIG. 2 is a diagram illustrating a flow of data during a write operation according to the embodiment;

FIG. 3 is a diagram illustrating a flow of data during a read operation according to the embodiment;

FIG. 4 is a diagram for explaining an example of an encoding method performed by an encoding circuit according to the embodiment;

FIG. 5 is a block diagram illustrating a configuration example of a decoding circuit according to the embodiment;

FIG. 6 is a block diagram illustrating a configuration example of the encoding circuit according to the embodiment;

FIG. 7 is a diagram illustrating an example of data rotation and interleaving according to the embodiment;

FIG. 8 is a diagram for explaining an example of a method of calculating the number of rotations according to the embodiment;

FIG. 9 is a diagram illustrating an example of a configuration of a matrix after data rotation and interleaving according to the embodiment;

FIG. 10 is a diagram for explaining a detailed configuration example of a rotation circuit, a reverse rotation circuit, and peripheral circuits thereof according to the embodiment; and

FIG. 11 is a diagram illustrating an example of a waveform of each signal in the decoding circuit according to the embodiment.

### DETAILED DESCRIPTION

According to the present embodiment, a memory system includes a nonvolatile first memory, a volatile second memory, and a memory controller. The memory controller reads a first symbol string from the first memory. The memory controller performs, for each of a plurality of first sections obtained by dividing the read first symbol string in units of a first length, a first conversion operation of converting an arrangement order of symbols in one first section with a conversion pattern corresponding to a position of one first section in the first symbol string. The memory controller performs, for each of the plurality of first sections after the first conversion operation, a second conversion operation of converting an arrangement order of symbols in one first section with a conversion pattern common to the plurality of first sections. The memory controller performs decoding using parity on the plurality of first sections after the second conversion operation. The memory controller performs, for each of the plurality of first sections after the decoding, a third conversion operation which is a reverse conversion of the conversion by the second conversion operation. The memory controller performs, for each of the plurality of first sections after the third conversion operation, a fourth conversion operation which is a reverse conversion of the conversion by the first conversion operation. The memory controller stores a second symbol string obtained by combining the plurality of first sections after the fourth conversion operation in the second memory.

The memory system, a decoding circuit, and a decoding method according to the embodiment will be described below in detail with reference to the accompanying drawings. Note that the present invention is not limited by this embodiment.

### Embodiment

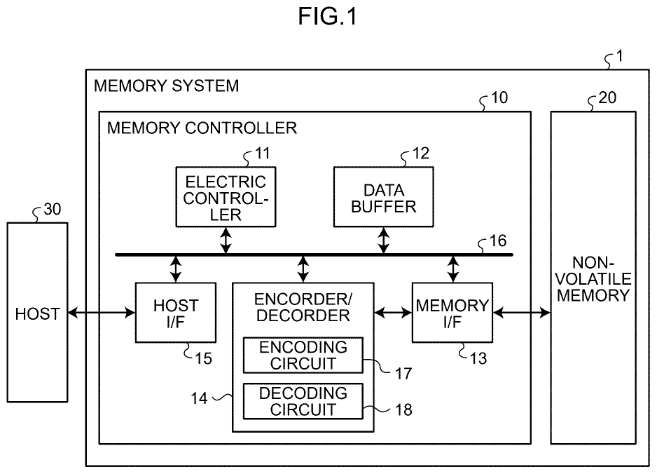

FIG. 1 is a block diagram illustrating a schematic configuration example of the memory system according to the embodiment. As illustrated in FIG. 1, the memory system 1 includes a memory controller 10 and a nonvolatile memory 20. The memory system 1 can be connected to a host 30, and FIG. 1 illustrates a state in which the memory system 1 is connected to the host 30. The host 30 may be, for example, an electronic device such as a personal computer or a mobile terminal.

The nonvolatile memory 20 is a nonvolatile memory that stores data in a nonvolatile manner, and is, for example, a NAND memory. In the following description, a case where a NAND memory is used as the nonvolatile memory 20 is illustrated, but a storage device other than the NAND memory, such as a three-dimensional structure flash memory, a resistance random access memory (ReRAM), or a ferroelectric random-access memory (FeRAM), may be used as the nonvolatile memory 20. Further, it is not essential that the nonvolatile memory 20 is a semiconductor memory, and the present embodiment can be applied to various storage media other than the semiconductor memory. Note that the nonvolatile memory 20 is an example of the first memory.

The memory system 1 may be a memory card or the like in which the memory controller 10 and the nonvolatile memory 20 are configured as one package, or may be a solid-state drive (SSD) or the like.

The memory controller 10 controls writing to the nonvolatile memory 20 in accordance with a write request from the host 30. In addition, the memory controller 10 controls reading from the nonvolatile memory 20 in accordance with a read request from the host 30. The memory controller 10 includes a host interface (I/F) 15, a memory I/F 13, an electric controller 11, an encoder/decoder 14, and a data buffer 12. The host I/F 15, the memory I/F 13, the electric controller 11, the encoder/decoder 14, and the data buffer 12 are connected to each other by an internal bus 16. Some or all of the operations of the components of the memory controller 10 may be implemented by a central processing unit (CPU) executing firmware, or may be implemented by hardware.

The host I/F 15 is a circuit that performs a process according to an interface standard between the host I/F and the host 30 and outputs an instruction received from the host 30, user data to be written, and the like to the internal bus 16. In addition, the host I/F 15 transmits, to the host 30, user data read from the nonvolatile memory 20 and restored, a response from the electric controller 11, and the like.

The memory I/F 13 is a circuit that performs a write operation or a read operation on the nonvolatile memory 20 based on an instruction of the electric controller 11.

The electric controller 11 is a processor that comprehensively controls the components of the memory system 1. The electric controller 11 is, for example, a central processing unit (CPU). When a request is received from the host 30 via the host I/F 15, the electric controller 11 performs control according to the request. For example, the electric controller 11 instructs the memory I/F 13 to write user data and parity to the nonvolatile memory 20 in accordance with a request from the host 30. In addition, the electric controller 11 instructs the memory I/F 13 to read user data and parity from the nonvolatile memory 20 in accordance with a request from the host 30.

In addition, when receiving a write request of user data from the host 30, the electric controller 11 accumulates the user data in the data buffer 12 and determines a storage area (memory area) of the user data in the nonvolatile memory 20. That is, the electric controller 11 manages the write destination of the user data. The correspondence between the logical address of the user data received from the host 30 and the physical address indicating the storage area on the nonvolatile memory 20 in which the user data is stored is stored as an address conversion table.

In addition, when receiving a read request from the host 30, the electric controller 11 converts the logical address designated by the read request into a physical address by using the above-described address conversion table, and instructs the memory I/F 13 to read from the physical address.

The data buffer 12 is composed of a volatile memory. The data buffer 12 temporarily stores the user data received from the host 30 by the memory controller 10 until the user data is stored in the nonvolatile memory 20. In addition, the data buffer 12 temporarily stores the user data read from the nonvolatile memory 20 until the user data is transmitted to the host 30. As the data buffer 12, a general-purpose memory such as a static random access memory (SRAM) or a dynamic random access memory (DRAM) can be used, for example. Note that the data buffer 12 is an example of the second memory.

The user data transmitted from the host 30 is transferred to the internal bus 16 and temporarily stored in the data buffer 12. The encoder/decoder 14 encodes the user data to generate a codeword. In addition, the encoder/decoder 14 decodes a received word, which is data read from the nonvolatile memory 20, to restore the user data. Therefore, the encoder/decoder 14 includes an encoding circuit 17 and a decoding circuit 18. Note that the data encoded by the encoder/decoder 14 may include control data or the like used inside the memory controller 10 in addition to the user data.

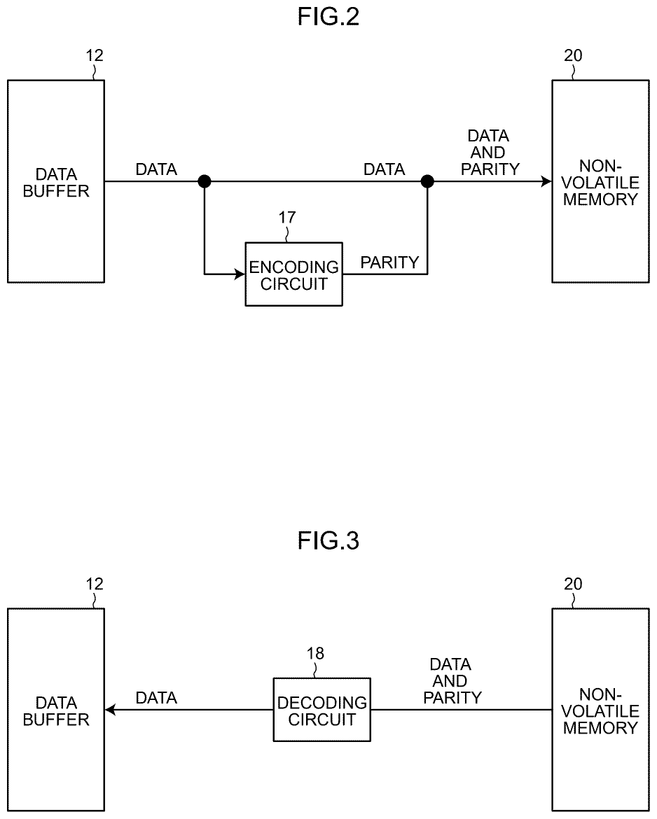

FIG. 2 is a diagram illustrating a flow of data during a write operation according to the embodiment.

In response to a write request from the host 30, the electric controller 11 instructs the host I/F 15 to receive user data. The host I/F 15 receives user data from the host 30 and stores the received user data in the data buffer 12.

The electric controller 11 instructs the encoding circuit 17 to encode the user data. At the time of instruction, the electric controller 11 determines a storage location (storage address) of the codeword in the nonvolatile memory 20, and instructs the memory I/F 13 to the determined storage location as well.

The encoding circuit 17 encodes, based on an instruction from the electric controller 11, the user data on the data buffer 12 to generate parity. The encoding scheme can adopt, for example, an encoding scheme using algebraic codes such as a Bose-Chaudhuri-Hocquenghem (BCH) code and a Reed-Solomon (RS) code, and an encoding scheme (a product code or the like) using these codes as component codes in the row direction and the column direction. The memory I/F 13 performs control of writing the user data stored in the data buffer 12 and the parity generated by the encoding circuit 17 to a storage location on the nonvolatile memory 20 instructed by the electric controller 11.

FIG. 3 is a diagram illustrating a flow of data during a read operation according to the embodiment.

In response to a read request from the host 30, the electric controller 11 designates an address on the nonvolatile memory 20 and instructs the memory I/F 13 to perform reading. In addition, the electric controller 11 instructs the decoding circuit 18 to start decoding. The memory I/F 13 reads the data and the parity from the designated address of the nonvolatile memory 20 in accordance with the instruction of the electric controller 11, and inputs the received word consisting of the read data and the parity to the decoding circuit 18. The decoding circuit 18 decodes the received word read from the nonvolatile memory 20. The data on which error correction has been performed by decoding by the decoding circuit 18 is stored in the data buffer 12.

The host 30 instructs the host I/F 15 to output the user data at a predetermined timing. The host I/F 15 outputs the error-corrected date in the data buffer 12 to the host 30 according to the instruction of the electric controller 11.

An error correction code used in the present embodiment will now be described. In the present embodiment, the encoding circuit 17 generates a product code as an example. The product code has a structure in which each information symbol, which is a constituent unit of user data, is protected by a Hamming code including a parity symbol having a predetermined parity length in each of the row direction and the column direction. That is, in the product code, all symbols are doubly protected by component codes in the row direction and the column direction. One symbol is composed of, for example, one bit (an element of a binary field) or an element of an alphabet such as a finite field other than the binary field. Note that, for ease of description, an error correction code of a binary field in which one symbol is composed of one bit will be described below as an example.

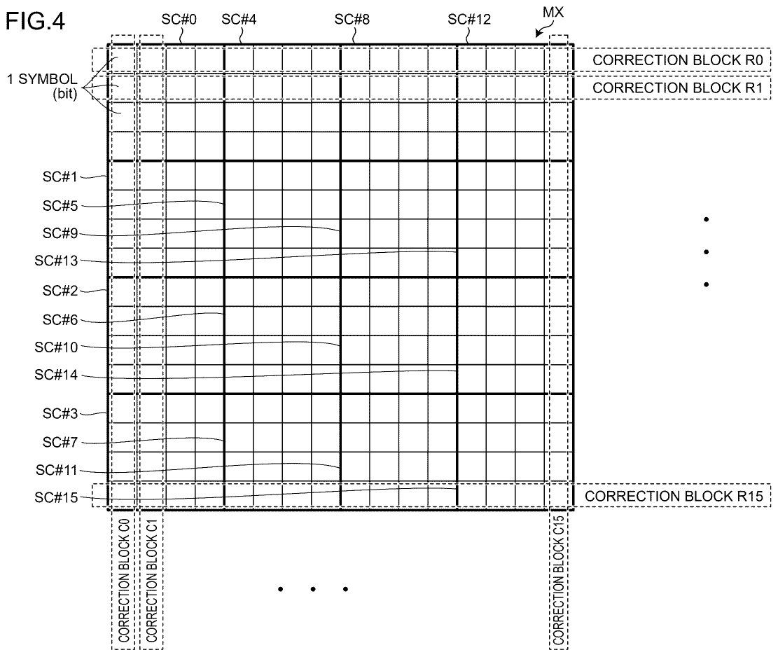

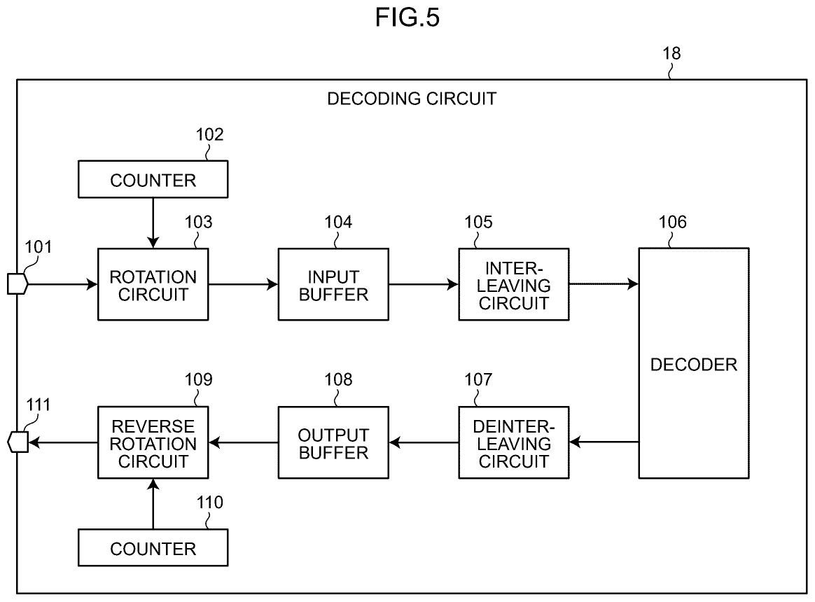

FIG. 4 is a diagram for explaining an example of an encoding method performed by the encoding circuit 17 according to the embodiment.

According to the example illustrated in FIG. 4, a matrix MX is configured in which 16 sections SC are arranged in the row direction and the column direction. Each section SC is divided data generated by dividing a symbol string constituting user data for each predetermined length (here, 16 symbols). The 16 symbols constituting the section SC are arranged as a submatrix of four symbols by four symbols. Each section SC is given a section number corresponding to the position in the symbol string. For example, a number 0 is given as a section number to a section SC constituted by 16 symbols from the head to the 16th symbol of the symbol string. A number 1 is given as a section number to a section SC constituted by 16 symbols from the 17th symbol to the 32nd symbol starting from the head of the symbol string. Hereinafter, a section SC whose section number is X may be denoted as a section SC #X.

The 16 sections SC are arranged at positions corresponding to the respective section numbers, thereby configuring a matrix MX of four sections SC by four sections SC. Since each section SC is configured as a submatrix of four symbols by four symbols, the matrix MX is a matrix of 16 symbols by 16 symbols.

For the matrix MX, a correction block is configured for each row and each column. For example, in the column direction, a correction block C is configured for each of 16 columns. In the row direction, a correction block R is configured for each of 16 rows.

In order to distribute errors, interleaving is performed on each section SC, within a submatrix constituting a section SC. Interleaving is an operation of converting the arrangement order of symbols such that adjacent symbols are separated from each other.

The conversion pattern by interleaving is common to all the sections SC. Therefore, when an error occurs in a specific cycle, the error is concentrated on a specific row or a specific column of the matrix MX, which may make the error correction difficult. For example, when an error occurs in a cycle of the number of symbols constituting the section SC (16 symbols in the example illustrated in FIG. 4), the error is located at a position common to a plurality of sections SC in each section SC. Therefore, in the matrix MX, errors are concentrated on a specific correction block C or a specific correction block R.

In the interleaving, if the conversion pattern is varied for each section SC, it is possible to increase the resistance to the periodic error as described above. However, in order to perform interleaving with different conversion patterns for each section SC, the scale of the circuit that performs interleaving increases, and the cost of the memory system increases.

In order to improve the resistance to periodic errors while suppressing the circuit scale of the decoding circuit 18 as much as possible, in the decoding circuit 18, each section SC is subjected to another conversion process in addition to interleaving. Specifically, each section SC is subjected to cyclic shift before interleaving. The number of shifts by the cyclic shift is varied according to the section number. Thus, even if a periodic error as described above occurs, it is possible to prevent errors from concentrating on a specific correction block C or a specific correction block R.

Hereinafter, a process of cyclic shift in a certain direction is denoted as data rotation or simply rotation. In addition, the number of shifts is denoted as the number of rotations.

FIG. 5 is a block diagram illustrating a configuration example of the decoding circuit 18 according to the embodiment.

The decoding circuit 18 includes an input terminal 101, a counter 102, a rotation circuit 103, an input buffer 104, an interleaving circuit 105, a decoder 106, a deinterleaving circuit 107, an output buffer 108, a reverse rotation circuit 109, a counter 110, and an output terminal 111.

The user data read from the nonvolatile memory 20 is input to the input terminal 101.

The counter 102 counts the number of symbols input from the input terminal 101 in the symbol string constituting the user data input to the input terminal 101. In addition, the counter 102 calculates, based on the count value, the number of sections SC input from the input terminal 101 in the symbol string constituting the user data input to the input terminal 101. The number of sections SC obtained by calculation is interpreted in the rotation circuit 103 as the section number of the section SC being processed for data rotation.

The rotation circuit 103 is a circuit that performs data rotation. The rotation circuit 103 acquires the number of rotations based on the section number acquired by the counter 102, and performs data rotation by the acquired number of rotations.

The input buffer 104 is configured to be able to store a symbol string of one section SC. The section SC after the data rotation is stored in the input buffer 104.

The interleaving circuit 105 performs interleaving on the section SC stored in the input buffer 104.

The decoder 106 configures a matrix MX by a plurality of sections SC after interleaving, and corrects an error included in the matrix MX by performing decoding using parity on the matrix MX.

The deinterleaving circuit 107 performs deinterleaving on each section SC included in the matrix MX after the error is corrected by decoding. Deinterleaving is a reverse conversion of the conversion by interleaving.

The output buffer 108 is configured to be able to store a symbol string of one section SC. The deinterleaved section SC is stored in the output buffer 108.

The counter 110 counts the symbols output from the reverse rotation circuit 109. In addition, the counter 110 calculates, based on the count value, the number of sections SC output from the reverse rotation circuit 109. The number of sections SC obtained by calculation is interpreted as the section number of the section SC being processed for reverse data rotation in the reverse rotation circuit 109.

The reverse rotation circuit 109 is a circuit that performs reverse data rotation. The reverse data rotation is a reverse conversion of the conversion by the data rotation. The reverse rotation circuit 109 acquires the number of rotations based on the section number acquired by the counter 110, and performs reverse data rotation by the acquired number of rotations.

The plurality of sections SC after the reverse rotation is combined and output from the output terminal 111 as a symbol string. The symbol string output from the output terminal 111 is stored in the data buffer 12 as user data after error correction.

The data rotation operation performed by the rotation circuit 103 is an example of a first conversion operation. The rotation circuit 103 is an example of a first conversion circuit. The interleaving operation performed by the interleaving circuit 105 is an example of a second conversion operation. The interleaving circuit 105 is an example of a second conversion circuit. The deinterleaving operation performed by the deinterleaving circuit 107 is an example of a third conversion operation. The deinterleaving circuit 107 is an example of a third conversion circuit. The reverse rotation operation performed by the reverse rotation circuit 109 is an example of a fourth conversion operation. The reverse rotation circuit 109 is an example of a fourth conversion circuit.

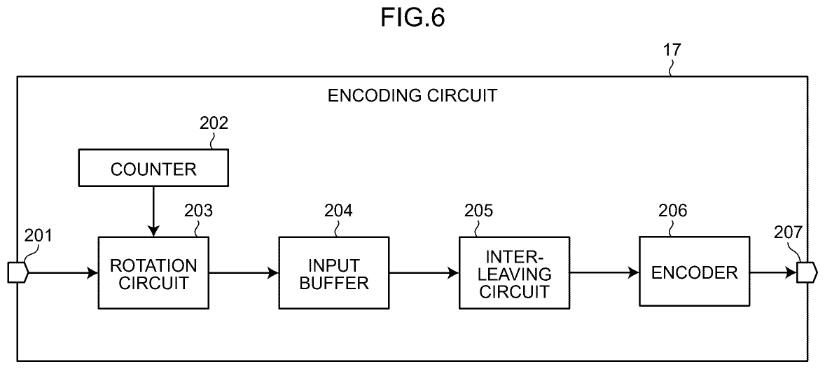

FIG. 6 is a block diagram illustrating a configuration example of the encoding circuit 17 according to the embodiment.

The encoding circuit 17 includes an input terminal 201, a counter 202, a rotation circuit 203, an input buffer 204, an interleaving circuit 205, an encoder 206, and an output terminal 207.

User data read from the data buffer 12 is input to the input terminal 201.

The counter 202, the rotation circuit 203, the input buffer 204, and the interleaving circuit 205 perform the same operations as those of the counter 102, the rotation circuit 103, the input buffer 104, and the interleaving circuit 105.

That is, the counter 202 counts the number of symbols input from the input terminal 201 in the symbol string constituting the user data input to the input terminal 201. In addition, the counter 202 calculates, based on the count value, the number of sections SC input from the input terminal 201 in the symbol string constituting the user data input to the input terminal 201. The number of sections SC obtained by calculation is interpreted in the rotation circuit 203 as the section number of the section SC being processed for data rotation.

The rotation circuit 203 is a circuit that performs data rotation. The rotation circuit 203 acquires the number of rotations based on the section number acquired by the counter 202, and performs data rotation by the acquired number of rotations.

The input buffer 204 is configured to be able to store a symbol string of one section SC. The section SC after the data rotation is stored in the input buffer 204.

The interleaving circuit 205 performs interleaving on the section SC stored in the input buffer 204.

The encoder 206 configures a matrix MX by the plurality of sections SC after interleaving, and generates parity of a product code by performing the encoding of the product code on the matrix MX.

The output terminal 207 outputs the parity generated by the encoder 206.

The data rotation operation performed by the rotation circuit 203 is an example of a fifth conversion operation. The interleaving operation performed by the interleaving circuit 205 is an example of a sixth conversion operation.

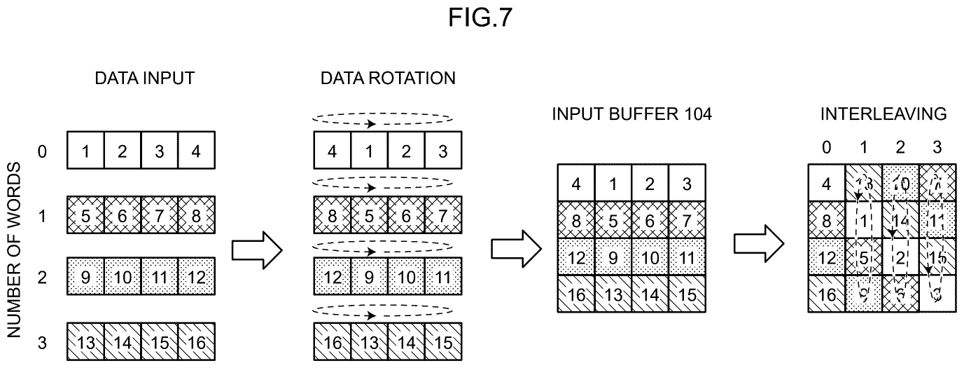

FIG. 7 is a diagram illustrating an example of data rotation and interleaving according to the embodiment. Here, for ease of understanding, a symbol number indicating an input order is given to each symbol of one section SC. Further, in this figure, the process in the decoding circuit 18 is described as an example, but the same process is also performed in the encoding circuit 17.

First, the user data of one section SC is divided into a plurality of words. A word is a unit having a length that is a divisor of the length of one section SC. Note that a word is an example of a subsection.

In the example illustrated in FIG. 7 and the subsequent figures, it is assumed that one word is composed of four symbols. The first to fourth symbols constitute a word 0, the fifth to eighth symbols constitute a word 1, the ninth to twelfth symbols constitute a word 2, and the thirteenth to sixteenth symbols constitute a word 3.

The rotation circuit 103 performs rotation for each word. That is, the rotation circuit 103 applies a cyclic shift to a group consisting of the first to fourth symbols, applies a cyclic shift to a group consisting of the fifth to eighth symbols, applies a cyclic shift to a group consisting of the ninth to twelfth symbols, and applies a cyclic shift to a group consisting of the thirteenth to sixteenth symbols. Note that FIG. 7 illustrates an example in which the data rotation is performed in a case where the direction of the data rotation is rightward and the number of rotations is 1. That is, a process of cyclically shifting to the right by one symbol is performed for each word.

In the input buffer 104, four words on which data rotation has been performed are connected in the row direction to generate a structure of a submatrix of four symbols by four symbols that is similar to one section SC.

In the interleaving operation, predetermined conversion is performed such that adjacent symbols are separated from each other. In the example illustrated in FIG. 7, each column of the submatrix is cyclically shifted downward by the same number as the column number. Thus, the symbols adjacent to each other in the row direction or the column direction before the interleaving operation are separated from each other after the interleaving operation. Note that the example of the interleaving operation is not limited to the example illustrated in FIG. 7.

As described above, the conversion pattern by the interleaving operation is common to all the sections SC. On the other hand, the number of rotations in the data rotation operation is varied according to the section number.

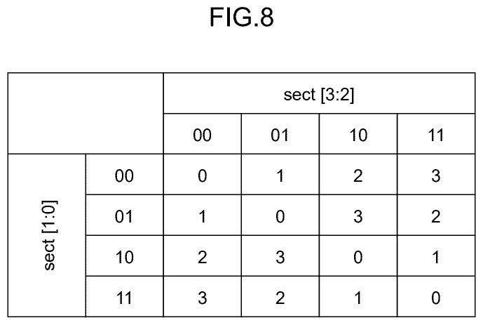

FIG. 8 is a diagram for explaining an example of a method of calculating the number of rotations according to the embodiment. In this figure, sect is a section number in binary notation.

In the example illustrated in FIG. 8, the number of rotations is obtained by calculating an exclusive OR of sect <1:0> and sect <3:2>. Therefore, the number of rotations is varied in the range of 0 to 3 according to the section number as illustrated in the figure. As a result, the conversion pattern by the data rotation operation is varied for each section SC according to the section number.

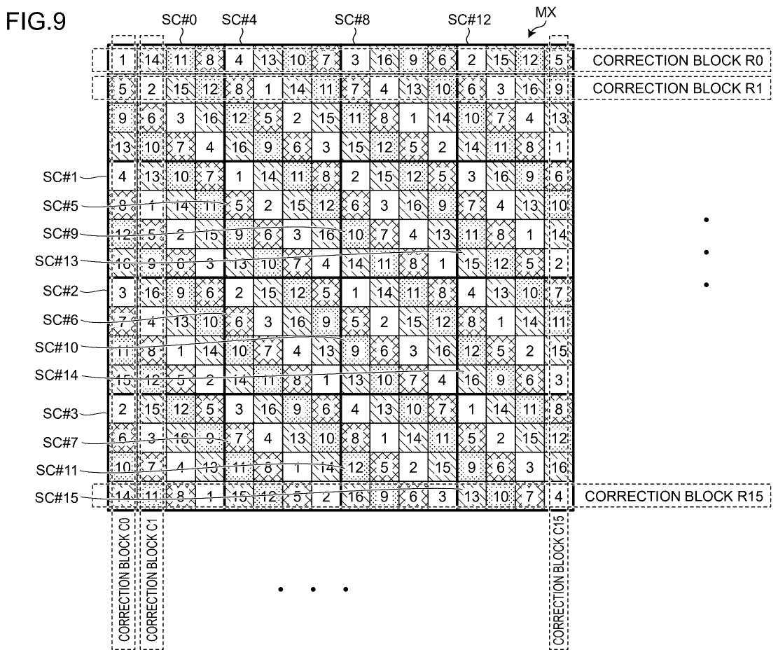

FIG. 9 is a diagram illustrating an example of a configuration of a matrix MX after data rotation and interleaving according to the embodiment. A symbol number indicating an input order is displayed on each symbol in each section SC.

As illustrated in FIG. 9, the arrangement order of symbols in each section SC is different for each section SC (more precisely, for each of the number of rotations applied). Therefore, even if a periodic error of a period of a section SC occurs, the error is not concentrated on the specific correction block C or the specific correction block R.

For example, the symbols whose input order is “1” in each section SC are distributed to a plurality of correction blocks C and a plurality of correction blocks R. That is, the symbols whose input order is “1” in each section SC are not concentrated on the specific correction block C or the specific correction block R. Therefore, even if an error occurs in the first symbol in the input order in each section SC, the error is not concentrated on the specific correction block C or the specific correction block R. The same applies to a symbol whose input order is other than “1”.

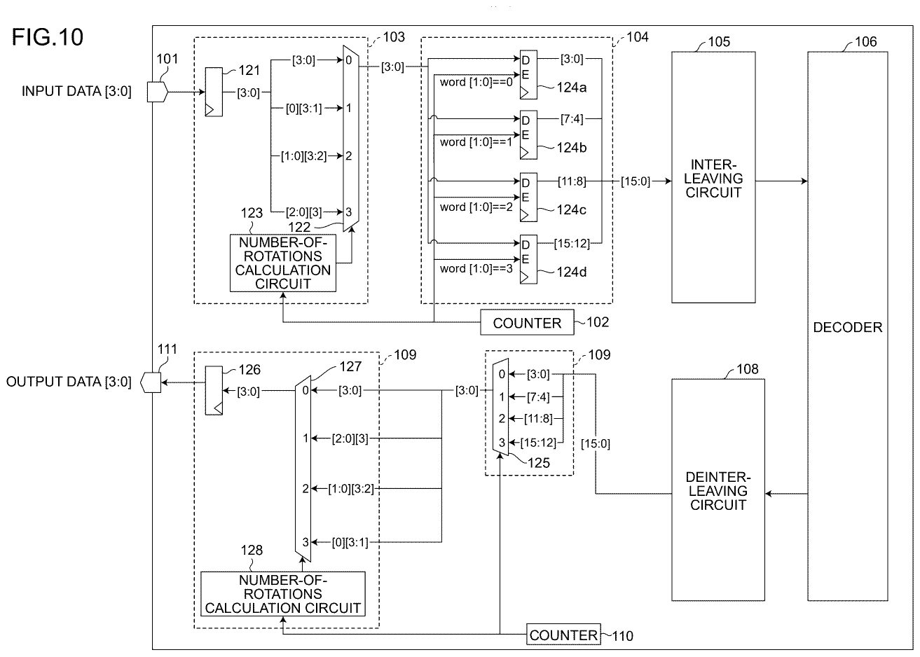

FIG. 10 is a diagram for explaining a detailed configuration example of the rotation circuit 103, the reverse rotation circuit 109, and the peripheral circuits thereof according to the embodiment. In this figure, it is assumed that, as an example, data is input to the input terminal 101 as a 4-bit width signal.

As described above, the counter 102 counts the number of symbols input from the input terminal 101. Here, it is assumed that data is input as a 4-bit width signal, and 4 bits constitute one word. Therefore, the counter 102 counts the number of symbols input from the input terminal 101 in units of words. That is, the counter 102 counts the number of words input from the input terminal 101.

The counter 102 calculates the section number sect based on the count value word of the number of words and the following Equation (1).

$$sect < 3 : 0 > = word < 5 : 2 > \qquad ( 1 )$$

Further, the counter 102 generates enable signals to be input to E terminals of a latch circuit 124a, a latch circuit 124b, a latch circuit 124c, and a latch circuit 124d, which will be described below.

The rotation circuit 103 includes a latch circuit 121, a selector 122, and a number-of-rotations calculation circuit 123.

The latch circuit 121 latches data input from the input terminal 101. Note that data is input to the input terminal 101 as a 4-bit width signal. Therefore, the latch circuit 121 is configured to latch one-word data.

The selector 122 includes four input terminals. Data obtained by performing data rotation of the number of rotations “0” on the one-word data latched by the latch circuit 121 (that is, data that is not data-rotated) is input to one input terminal of the four input terminals of the selector 122. Data obtained by performing data rotation of the number of rotations “1” on the one-word data latched by the latch circuit 121 is input to the other input terminal of the four input terminals of the selector 122. Data obtained by performing data rotation of the number of rotations “2” on the one-word date latched by the latch circuit 121 is input to still another input terminal of the four input terminals of the selector 122. Data obtained by performing data rotation of the number of rotations “3” on the one-word data latched by the latch circuit 121 is input to the remaining one input terminal of the four input terminals of the selector 122.

The number-of-rotations calculation circuit 123 calculates the number of rotations by calculation using the section number sect acquired by the counter 102. For example, according to the example illustrated in FIG. 8, the number-of-rotations calculation circuit 123 acquires the number of rotations by calculating an exclusive OR of sect <1:0> and sect <3:2>. The number of rotations acquired by the number-of-rotations calculation circuit 123 is input to the selector 122 as a selection signal. The selector 122 outputs the rotated (or non-rotated) one-word data selected by the selection signal.

Therefore, when four-word data constituting a certain section SC is sequentially input to the rotation circuit 103, the rotation circuit 103 can perform data rotation according to the section number sect on each of the four-word data.

The input buffer 104 includes a latch circuit 124a, a latch circuit 124b, a latch circuit 124c, and a latch circuit 124d. These latch circuits 124 includes D terminals and E terminals. The D terminal of each of the latch circuits 124 is connected to the output terminal of the selector 122 of the rotation circuit 103. An enable signal generated by the counter 102 is input to the E terminal of each of the latch circuits 124.

The counter 102 generates an enable signal of each of the latch circuits 124 based on the count value word of the number of words. When word <1:0> is 0, the counter 102 sets the enable signal of the latch circuit 124a to High. When word <1:0> is 1, the counter 102 sets the enable signal of the latch circuit 124b to High. When word <1:0> is 2, the counter 102 sets the enable signal of the latch circuit 124c to High. When word <1:0> is 3, the counter 102 sets the enable signal of the latch circuit 124d to High.

The one-word data latched by the latch circuit 124a, the one-word data latched by the latch circuit 124b, the one-word data latched by the latch circuit 124c, and the one-word data latched by the latch circuit 124d are combined in this order to generate data <15:0> of one section SC. The data <15:0> of one section SC is input to the interleaving circuit 105.

The data <15:0> of one section SC is input to the decoder 106 after an interleaving operation is performed by the interleaving circuit 105. When the data <15:0> of the 16 section SC is input, the decoder 106 configures a matrix MX by the data <15:0> of the 16 section SC, and performs error correction by decoding the matrix MX. The decoder 106 sequentially outputs the matrix MX after the error correction as data of the 16 section SC. Each time the data <15:0> of one section SC output from the decoder 106 is output, the data <15:0> of the one section SC is deinterleaved by the deinterleaving circuit 107.

The counter 110 counts the number of symbols output from the deinterleaving circuit 107 in units of words. Further, the counter 110 calculates the section number sect based on the count value of the number of words and Equation (1).

The output buffer 108 includes a selector 125. The selector 125 includes four input terminals. One-word data <3:0> of the data <15:0> of one section SC output from the deinterleaving circuit 107 is input to one input terminal of the four input terminals of the selector 125. One-word data <7:4> of the data <15:0> of one section SC output from the deinterleaving circuit 107 is input to another input terminal of the four input terminals of the selector 125. One-word data <11:8> of the data <15:0> of one section SC output from the deinterleaving circuit 107 is input to still another input terminal of the four input terminals of the selector 125. One-word data <15:12> of the data <15:0> of one section SC output from the deinterleaving circuit 107 is input to the remaining one input terminal of the four input terminals of the selector 125. That is, different words among the four words constituting the data <15:0> of one section SC are input to the four input terminals of the selector 125.

The word <1:0> of the count value word of the number of words by the counter 110 is input to the selector 125 as a selection signal. If word <1:0> is 0, the selector 125 outputs one-word data <3:0> of the data <15:0> of one section SC. If word <1:0> is 1, the selector 125 outputs one-word data <7:4> of the data <15:0> of one section SC. If word <1:0> is 2, the selector 125 outputs one-word data <11:8> of the data <15:0> of one section SC. If word <1:0> is 3, the selector 125 outputs one-word data <15:11> of the data <15:0> of one section SC.

The reverse rotation circuit 109 includes a latch circuit 126, a selector 127, and a number-of-rotations calculation circuit 128.

The selector 127 includes four input terminals. Data obtained by performing reverse data rotation of the number of rotations “0” on the one-word data output from the selector 125 (that is, data that is not reverse-data-rotated) is input to one input terminal of the four input terminals of the selector 127. Data obtained by performing reverse data rotation of the number of rotations “1” on the one-word data output from the selector 125 is input to the other input terminal of the four input terminals of the selector 127. Data obtained by performing reverse data rotation of the number of rotations “2” on the one-word data output from the selector 125 is input to still another input terminal of the four input terminals of the selector 127. Data obtained by performing reverse data rotation of the number of rotations “3” on the one-word data output from the selector 125 is input to the remaining one input terminal of the four input terminals of the selector 127.

The number-of-rotations calculation circuit 128 calculates the number of rotations by the same calculation as that of the number-of-rotations calculation circuit 123 using the section number sect input from the counter 110. The number of rotations acquired by the number-of-rotations calculation circuit 128 is input to the selector 127 as a selection signal. The selector 127 outputs the reverse-rotated (or non-reverse-rotated) one-word data selected by the selection signal. The one-word data output from the selector 127 is latched by the latch circuit 126.

Therefore, when four-word data constituting a certain section SC is input to the reverse rotation circuit 109, the reverse rotation circuit 109 can perform reverse conversion of data rotation according to the section number sect on each of the four-word data.

The one-word data latched by the latch circuit 126 is output from an output terminal 111.

As is apparent from FIG. 10, the rotation circuit 103, the reverse rotation circuit 109, the counter 102, and the counter 110 are realized by a simple circuit configuration. That is, according to the embodiment, an operation of conversion of a conversion pattern different for each section SC is realized by a simple circuit.

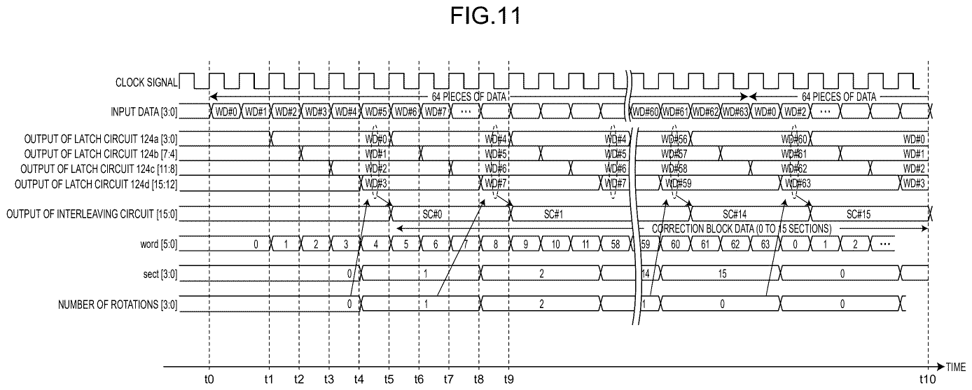

FIG. 11 is a diagram illustrating an example of a state of each signal in the decoding circuit 18 according to the embodiment. This figure illustrates the transitions of, from the top, the waveform of the clock signals that drive the elements of the decoding circuit 18, the input data input to the input terminal 101, the output of the latch circuit 124a, the output of the latch circuit 124b, the output of the latch circuit 124c, the output of the latch circuit 124d, the output of the interleaving circuit 105, the number of words word counted by the counter 102, the section number sect acquired by the counter 102, and the number of rotations acquired by the number-of-rotations calculation circuit 123. Note that, in this figure, WD #Y (Y is an integer of 0 or more) indicates the Y-th word from the head of the user data input to the input terminal 101.

In FIG. 11, input of user data is started at time to. Counting of the number of words word by the counter 102 is started from time t1 at which two clock cycles have elapsed from time t0. In the period from the time t0 to the time t4 five clock cycles after the time t0, the section number sect acquired by the counter 102 is “0”, and the number of rotations acquired by the number-of-rotations calculation circuit 123 in the period is “0”.

At the time t1 at which two clock cycles have elapsed from the time t0, the word WD #0 is latched by the latch circuit 124a. At the time t2 at which one clock cycle has elapsed from the time t1, the word WD #1 is latched by the latch circuit 124b. At the time t3 at which one clock cycle has elapsed from the time t2, the word WD #2 is latched by the latch circuit 124c. At the time t4 at which one clock cycle has elapsed from the time t3, the word WD #3 is latched by the latch circuit 124d.

As described above, the number of rotations acquired by the number-of-rotations calculation circuit 123 is “0” from the time t0 to the time t4. Therefore, the words WD #0 to WD #3 latched by the latch circuits 124 corresponding to the time t1 to the time t4, respectively, are subjected to data rotation of the number of rotations “0” (that is, not subjected to data rotation).

At the time t5 at which one clock cycle has elapsed from time t4, the words WD #0 to WD #3 are acquired as the data of the section SC #0 by the interleaving circuit 105, and interleaving is performed on data of the section SC #0.

In the period from the time t4 to the time t8 at which four clock cycles have elapsed from the time t4, the section number sect acquired by the counter 102 is “1”, and the number of rotations acquired by the number-of-rotations calculation circuit 123 in the period is “1”.

At the time t5, the word WD #4 is latched by the latch circuit 124a. At the time t6 at which one clock cycle has elapsed from the time t5, the word WD #5 is latched by the latch circuit 124b. At the time t7 at which one clock cycle has elapsed from the time t6, the word WD #6 is latched by the latch circuit 124c. At the time t8 at which one clock cycle has elapsed from the time t7, the word WD #7 is latched by the latch circuit 124d.

From the time t4 to the time t8, the number of rotations acquired by the number-of-rotations calculation circuit 123 is “1”. Therefore, the words WD #0 to WD #3 latched by the latch circuits 124 corresponding to the time t5 to the time t8, respectively, are subjected to data rotation of the number of rotations “1”.

At the time t9 at which one clock cycle has elapsed from the time t8, each of the words WD #4 to WD #7 subjected to the data rotation of the number of rotations “1” is acquired as the data of the section SC #1 by the interleaving circuit 105, and interleaving is performed on the data of the section SC #1.

In this manner, data rotation and interleaving are sequentially performed on a plurality of sections SC while the number of rotations is changed for each section SC. At the time t10, the interleaving with respect to the section SC #15 which is the 16th section SC is completed, the matrix MX is configured by the 16th section SC in the decoder 106, and decoding is performed on the matrix MX.

As described above, according to the embodiment, in the read operation, the memory controller 10 reads the user data from the nonvolatile memory 20. The decoding circuit 18 performs decoding on the user data read from the nonvolatile memory 20. In the decoding circuit 18, the rotation circuit 103 performs, for each of a plurality of sections SC obtained by dividing a symbol string of user data in units of a predetermined length, data rotation of an arrangement order of symbols in one section SC by a different number according to a section number. As described above, the section number corresponds to the position of the section SC in the symbol string. That is, the rotation circuit 103 performs data rotation on each section SC by the number of rotations corresponding to the position of the section SC. The interleaving circuit 105 performs interleaving for each of the plurality of sections SC after the data rotation. The decoder 106 performs decoding using parity on the plurality of sections SC. The deinterleaving circuit 107 performs deinterleaving for each of the plurality of sections SC after decoding. The reverse rotation circuit 109 performs reverse data rotation for each section SC after deinterleaving. The decoding circuit 18 outputs a symbol string obtained by combining a plurality of sections SC after the reverse data rotation, and the memory controller 10 stores the symbol string output from the decoding circuit 18 in the data buffer 12.

In addition to interleaving in which the conversion pattern is common to a plurality of sections SC, each section SC is subjected to data rotation in which the conversion pattern differs according to the section number. Therefore, even if a periodic error occurs, it is possible to prevent errors from concentrating on a specific correction block C or a specific correction block R when a product code is configured by a plurality of sections SC. Therefore, the memory system 1 has high resistance to a periodic error.

In addition, as described with reference to FIG. 10, the data rotation in which the conversion pattern is varied according to the section number is realized by a simple circuit.

That is, according to the embodiment, it is possible to perform decoding with high resistance to a periodic error while suppressing an increase in the circuit scale of the decoding circuit 18. In other words, the decoding circuit 18 can suitably correct a periodic error.

According to the embodiment, the number-of-rotations calculation circuit 123 acquires the number of rotations by calculation using the section number. The rotation circuit 103 performs data rotation by the number of rotations acquired by the number-of-rotations calculation circuit 123.

Therefore, it is possible to convert the arrangement order of symbols for each section SC with a conversion pattern different for each section.

According to the embodiment, in the write operation, the memory controller 10 reads the user data from the data buffer 12. The encoding circuit 17 performs decoding on the user data read from the data buffer 12. In the encoding circuit 17, the rotation circuit 203 performs data rotation for each of the plurality of sections SC by the number of rotations corresponding to the position of the section SC as with the rotation circuit 103. The interleaving circuit 205 performs interleaving for each of the plurality of sections SC after the data rotation. The encoder 206 generates parity by performing encoding on the plurality of sections SC. The memory controller 10 writes the user data and the parity read from the data buffer 12 to the nonvolatile memory 20.

Therefore, decoding by the above-described decoding circuit 18 becomes possible.

Note that, in the above-described example, data rotation (that is, cyclic shift) has been described as an example of a process of converting the arrangement order of symbols with a conversion pattern different for each section SC. The process of converting the arrangement order of symbols with the conversion pattern different for each section SC is not limited to the data rotation (that is, the cyclic shift).

In addition, in the above-described example, the rotation circuit 103 performs data rotation for each of a plurality of words included in one section SC. The unit of data rotation performed by the rotation circuit 103 is not necessarily in units of words. The rotation circuit 103 may perform data rotation in units of sections SC, or may perform data rotation in units of two words.

In addition, in the above-described example, interleaving has been described as an example of a process of converting the arrangement order of symbols with a conversion pattern common to a plurality of sections SC. The process of converting the arrangement order of symbols with a conversion pattern common to a plurality of sections SC is not limited to interleaving.

In addition, in the above-described example, it has been described that the encoding using the error correction code of the product code is performed on the plurality of sections SC. The encoding of the plurality of sections SC is not limited thereto.

Note that each of the encoder/decoder 14, the encoding circuit 17, and the decoding circuit 18 described above is also applicable to a device other than the memory system 1. For example, each of the encoder/decoder 14, the encoding circuit 17, and the decoding circuit 18 is also applicable to a communication device.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile first memory;
a volatile second memory; and
a memory controller configured to:
read a first symbol string from the first memory;
perform, for each of a plurality of first sections obtained by dividing the read first symbol string in units of a first length, a first conversion operation of converting an arrangement order of symbols in one first section with a conversion pattern corresponding to a position of the one first section in the first symbol string;
perform, for each of the plurality of first sections after the first conversion operation, a second conversion operation of converting an arrangement order of symbols in one first section with a conversion pattern common to the plurality of first sections;
perform decoding using parity on the plurality of first sections after the second conversion operation;
perform, for each of the plurality of first sections after the decoding, a third conversion operation which is a reverse conversion of the conversion by the second conversion operation;
perform, for each of the plurality of first sections after the third conversion operation, a fourth conversion operation which is a reverse conversion of the conversion by the first conversion operation; and
store a second symbol string obtained by combining the plurality of first sections after the fourth conversion operation in the second memory.

2. The memory system according to claim 1, wherein
the memory controller is configured to,
in the first conversion operation, for each of a plurality of first subsections obtained by dividing one first section in units of a second length that is a divisor of a first length, convert an arrangement order of symbols in each first subsection included in the one first section with a conversion pattern corresponding to a position of the one first section in the first symbol string.

3. The memory system according to claim 2, wherein
the memory controller is configured to: in the first conversion operation,
acquire a first number by calculation using the position; and
cyclically shift an arrangement order of symbols in each first subsection by the first number of times.

4. The memory system according to claim 1, wherein
the memory controller is configured to:
read a third symbol string from the second memory;
perform, for each of a plurality of second sections obtained by dividing the read third symbol string in units of a first length, a fifth conversion operation of converting an arrangement order of symbols in one second section with a conversion pattern corresponding to a position of the one second section in the third symbol string;
perform, for each of the plurality of second sections after the fifth conversion operation, a sixth conversion operation of converting an arrangement order of symbols in one second section with a conversion pattern common to the plurality of second sections;
generate parity by error correction encoding on a group of the plurality of first sections after the sixth conversion operation; and
write the third symbol string and the parity to the second memory.

5. The memory system according to claim 1, wherein
the memory controller is configured to, in the second conversion operation, for each of the plurality of first sections after the first conversion operation, interleave all symbols in one first section.

6. The memory system according to claim 2, wherein
the memory controller is configured to, in the second conversion operation, for each of the plurality of first sections after the first conversion operation, interleave all symbols in one first section.

7. The memory system according to claim 3, wherein
the memory controller is configured to, in the second conversion operation, for each of the plurality of first sections after the first conversion operation, interleave all symbols in one first section.

8. The memory system according to claim 4, wherein
the memory controller is configured to, in the second conversion operation, for each of the plurality of first sections after the first conversion operation, interleave all symbols in one first section.

9. The memory system according to claim 1, wherein
the parity is parity of a product code.

10. A decoding circuit comprising:
a first terminal to which a first symbol string is input;
a first conversion circuit configured to convert, for each of a plurality of first sections obtained by dividing a first symbol string in units of a first length, an arrangement order of symbols in one first section with a conversion pattern corresponding to a position of the one first section in the first symbol string;
a second conversion circuit configured to convert, for each of the plurality of first sections after the conversion by the first conversion circuit, an arrangement order of symbols in one first section with a conversion pattern common to the plurality of first sections;
a decoder configured to perform decoding using parity on the plurality of first sections after the conversion by the second conversion circuit;
a third conversion circuit configured to perform, for each of the plurality of first sections after the decoding, a reverse conversion of the conversion by the second conversion circuit;
a fourth conversion circuit configured to perform, for each of the plurality of first sections after the reverse conversion by the third conversion circuit, reverse conversion of the conversion by the first conversion circuit; and
a second terminal configured to output a second symbol string obtained by combining the plurality of first sections after the reverse conversion by the fourth conversion circuit.

11. The decoding circuit according to claim 10, wherein
the first conversion circuit is configured to convert, for each of a plurality of first subsections obtained by dividing one first section in units of a second length that is a divisor of a first length, an arrangement order of symbols in each first subsection included in the one first section with a conversion pattern corresponding to a position of the one first section in the first symbol string.

12. The decoding circuit according to claim 11, wherein
the first conversion circuit is configured to:
acquire a first number by calculation using the position; and
cyclically shift an arrangement order of symbols in each first subsection by the first number of times.

13. The decoding circuit according to claim 10, wherein
the second conversion circuit is configured to interleave, for each of the plurality of first sections after conversion by the first conversion circuit, all symbols in one first section.

14. The decoding circuit according to claim 10, wherein
the parity is parity of a product code.

15. A method of controlling a memory system comprising a nonvolatile first memory and a volatile second memory, the method comprising:
reading a first symbol string from the first memory;
performing, for each of a plurality of first sections obtained by dividing the read first symbol string in units of a first length, a first conversion operation of converting an arrangement order of symbols in one first section with a conversion pattern corresponding to a position of the one first section in the first symbol string;
performing, for each of the plurality of first sections after the first conversion operation, a second conversion operation of converting an arrangement order of symbols in one first section with a conversion pattern common to the plurality of first sections;
performing decoding using parity on the plurality of first sections after the second conversion operation;
performing, for each of the plurality of first sections after the decoding, a third conversion operation which is a reverse conversion of the conversion by the second conversion operation;
performing, for each of the plurality of first sections after the third conversion operation, a fourth conversion operation which is a reverse conversion of the conversion by the first conversion operation; and
storing a second symbol string obtained by combining the plurality of first sections after the fourth conversion operation in the second memory.

16. The method according to claim 15, wherein
the performing the first conversion operation is converting, for each of a plurality of first subsections obtained by dividing one first section in units of a second length that is a divisor of a first length, an arrangement order of symbols in each first subsection included in the one first section with a conversion pattern corresponding to a position of the one first section in the first symbol string.

17. The method according to claim 16, wherein
the performing the first conversion operation comprises:
acquiring a first number by calculation using the position; and
cyclically shifting an arrangement order of symbols in each first subsection by the first number of times.

18. The method according to claim 15, further comprising:
reading a third symbol string from the second memory;
performing, for each of a plurality of second sections obtained by dividing the read third symbol string in units of a first length, a fifth conversion operation of converting an arrangement order of symbols in one second section with a conversion pattern corresponding to a position of the one second section in the third symbol string;
performing, for each of the plurality of second sections after the fifth conversion operation, a sixth conversion operation of converting an arrangement order of symbols in one second section with a conversion pattern common to the plurality of second sections;
generating parity by error correction encoding on a group of the plurality of first sections after the sixth conversion operation; and
writing the third symbol string and the parity to the second memory.

19. The method according to claim 15, wherein
the performing the second conversion operation is to interleave, for each of the plurality of first sections after the first conversion operation, all symbols in one first section.

20. The method according to claim 15, wherein
the parity is parity of a product code.
